(19) United States
(12) Patent Application Publication
(10) Pub. No.: US 2025/0166074 A1
(43) Pub. Date: May 22, 2025

(54) COMPUTER SYSTEM FOR IMPLEMENTING FINANCIAL COMMODITY PRICE ANALYSIS

(71) Applicant: Beijing Beiqing Boyu Information Technology Research Co., Ltd., Beijing (CN)

(72) Inventor: Sun Sun CHAN, Beijing (CN)

(21) Appl. No.: 18/948,955

(22) Filed: Nov. 15, 2024

(30) Foreign Application Priority Data
Nov. 17, 2023 (CN) 202311532797.5

(51) Int. Cl. G06Q 40/06; G06F 16/951; G06F 21/31; G06Q 30/0201

(52) U.S. Cl. CPC G06Q 40/06; G06F 16/951; G06F 21/31; G06Q 30/0206

(57) ABSTRACT

A computer system for implementing a financial commodity price analysis. This addresses the issue by real-time collection of microsecond-level transaction data for financial commodities, calculating the maximum weighted price for any period, and converting quantitative data into charts to display the most densely traded prices, trends, and price support and breakout points that stimulate changes in investor sentiment. The system accurately analyzes financial commodity price trends, serving as a reference for investors and a standard for bulk commodity price trading. The financial commodity price analysis system of this invention provides price analysis services based on big data, allowing for a more accurate assessment of market demand and competitive dynamics, thereby formulating more reasonable pricing strategies. The price suggestion generation module can flexibly adjust price suggestions based on different market positioning and cost considerations.

### CROSS REFERENCE TO RELATED APPLICATION

This patent application claims the benefit and priority of Chinese Patent Application No. 202311532797.5, filed with the China National Intellectual Property Administration on Nov. 17, 2023, the disclosure of which is incorporated by reference herein in its entirety as part of the present application.

### TECHNICAL FIELD

The present disclosure relates to the technical field of financial commodity price analysis, and in particular, to a computer-based financial commodity price analysis system.

### BACKGROUND

In a highly competitive market environment, companies need to develop reasonable financial commodity pricing strategies to enhance the competitiveness of their products. However, determining an appropriate price is a complex issue that requires consideration of various factors. User search volume, transaction volume, competitor prices, and aggregated prices are four key factors. User search volume reflects market demand, transaction volume reflects market trading conditions, while competitor prices and aggregated prices can serve as reference standards. Therefore, by analyzing these factors, a more competitive pricing strategy can be formulated for products of clients.

Upon searching, Chinese patent with application number CN202211109669.5 discloses a market price analysis platform for bulk commodities. The invention specifically includes a channel page and a market information page; in the market price analysis platform, source data of bulk financial commodity prices are aggregated and a statistical analysis is conducted. Based on this, a bulk commodity pricing system is established and is displayed on the channel page and market information page upon query, aiming to create a unified pricing reference standard in the market and optimize the comprehensive disparity in bulk financial commodity price information. The aforementioned patent has the following shortcomings: it cannot use user search volume, transaction volume, aggregated prices, and competitor prices as reference factors to assist in pricing, which needs improvement.

In the existing analysis of financial commodity markets, traditional price statistical methods are typically used, such as the conventional Open price, High price, Low price, Close price (OHLC) as reference prices. However, these prices are often susceptible to manipulation, leading to insufficient accuracy and fairness in price references. Additionally, in the current trading market, there is a lack of a method that utilizes a maximum weighted price (aggregated price) as a reference price to calculate technical indicators over arbitrary periods (Ichimoku Kinko Hyo), which prevents the provision of more detailed financial commodity price trend graphs. This invention patent addresses this issue by real-time collection of microsecond-level tick trading data for financial commodities, calculating the maximum weighted price for any period, and converting quantitative data into charts to display the most densely traded prices, trends, and price support and breakout points that stimulate changes in investor sentiment. This allows for precise analysis of financial commodity price trends, serving as a reference for investors and a standard for financial commodity price trading.

### SUMMARY

An objective of the present disclosure is to provide a computer-based financial commodity price analysis system and method so as to overcome the deficiencies of the prior art.

To achieve the above objective, the present disclosure adopts the following technical solutions:

A computer system for implementing financial commodity price analysis, including:
a data collection module configured to collect user search volume data, transaction volumes per unit time, competitor price data, and volume price indicators related to a target product through web crawlers and application programming interfaces (APIs);
a data analysis module configured to process and analyze the collected data, and calculate average, median, and standard deviation statistical indicators of user search volumes and competitor prices, where a price with a maximum transaction volume per unit time is referred to as an aggregated price, a first aggregated price (the highest transaction volume per unit time), a second aggregated price (the second highest transaction volume per unit time), a third aggregated price (the third highest transaction volume per unit time) . . . , and an N-th aggregated price (the N-th highest transaction volume per unit time) can be filtered out in a day;
a price suggestion generation module configured to generate a reasonable price suggestion based on data analysis results; set reference thresholds based on the user search volumes, transaction volumes, competitor prices, and aggregated prices, and generate a corresponding pricing suggestion based on the reference thresholds; and
a result display module configured to display the generated pricing suggestion to a user in the form of charts or other formats, allowing the user to intuitively understand rationality of a pricing strategy.

Preferably, the data collection module includes:
a web crawler collection unit configured to obtain the user search volume data from search engines;
an API interface collection unit configured to obtain the competitor price data from e-commerce platforms and other channels; and
a data storage unit configured to store the obtained data in a database for subsequent analysis and processing.

Preferably, the data analysis module includes:
a data preprocessing unit configured to perform cleaning, deduplication, and missing value filling operations on the obtained data to improve accuracy and completeness of the data;
a statistical analysis unit configured to calculate the average, median, standard deviation, and other statistical indicators of the user search volumes and the competitor prices, and perform visualization; and generate the volume price indicators based on transaction prices per unit time;
a data mining unit configured to discover potential correlations and trends based on statistical analysis results, to provide reference for subsequent price suggestion generation; and
a report generation unit configured to generate a report of analysis results in the form of charts or other formats, allowing the user to intuitively understand the data analysis results.

Preferably, the price suggestion generation module includes:
a threshold-based determining unit configured to determine a relationship between the user search volumes and the competitor prices based on the set thresholds, to provide a foundation for subsequent price suggestion generation;
a price suggestion generation unit configured to flexibly adjust the price suggestion based on market positioning and cost factors, to generate a reasonable pricing strategy; and
a suggestion feedback unit configured to provide the generated price suggestion to the user, allowing the user to timely adjust and optimize the pricing strategy.

Preferably, the result display module includes:
a chart display unit configured to visually present the data analysis results in one or more of the following formats: line charts, bar charts, or pie charts;
a custom settings unit configured to support the user to customize chart styles, colors, fonts, and other parameters, to meet needs of different users; and
a data export unit configured to support exporting the data analysis results in Excel or CSV formats, facilitating further processing and analysis by the user.

Preferably, the computer system for implementing financial commodity price analysis further includes:
a model establishment module configured to establish a prediction model or a decision tree model based on the analysis result, to provide more accurate reference for subsequent price suggestion generation.

The model establishment module includes:
a prediction model establishment unit configured to establish the prediction model based on historical data;
a model evaluation unit configured to evaluate the established prediction model, including calculation and analysis of mean squared error, precision, and recall metrics; and
a model optimization unit configured to optimize the established prediction model, including feature selection and parameter adjustment to improve prediction accuracy.

Preferably, the computer system for implementing financial commodity price analysis further includes:
a real-time monitoring module configured to monitor market changes and competitor dynamics in real time, allowing for timely adjustments to the price suggestion to maintain competitiveness.

The real-time monitoring module includes:
a data collection unit configured to collect market data and competitor data in real time;
a data analysis unit configured to analyze the collected data, including trend analysis and competitive comparison; and
an alert setting unit configured to set alerts based on analysis results to promptly detect the market changes and competitor dynamics.

Preferably, the computer system for implementing financial commodity price analysis further includes:
a graphical analysis module configured to calculate a bull-bear zone indicator for a target period, an aggregated price trend indicator (MTTI), and trading signals generated between the aggregated price and the bull-bear zone indicator as well as the MTTI indicator.

Preferably, the computer system for implementing financial commodity price analysis further includes:
a multi-user management module configured to support multiple users to view and edit analysis results simultaneously, to improve collaboration efficiency.

The multi-user management module includes:
a user permission management unit configured to set different permissions for different users, including viewing, editing, and deleting;
a user identity verification unit configured to verify user identities to ensure that only authorized users can access the system; and
a user log recording unit configured to record user operation logs for easy tracing and management.

The present disclosure has the following beneficial effects:
1. The computer system for implementing financial commodity price analysis of the present disclosure provides price analysis services based on big data, allowing for more accurate assessment of market demand and competition situation, thereby formulating more reasonable pricing strategies. The price suggestion generation module can flexibly adjust price suggestions based on different market positioning and cost considerations, making pricing strategies more operable.
2. The computer system for implementing financial commodity price analysis of the present disclosure can obtain user search volume and competitor price data in real time through the data collection module, allowing for timely updates to pricing strategies and enhancing market competitiveness.

The computer system for implementing financial commodity price analysis of the present disclosure can visually present analysis results to users in the form of charts or other formats through the result display module, allowing users to understand and accept the pricing strategies.

### BRIEF DESCRIPTION OF THE DRAWINGS

FIG. 1 is a schematic structural diagram of a computer system for implementing financial commodity price analysis according to the present disclosure; and

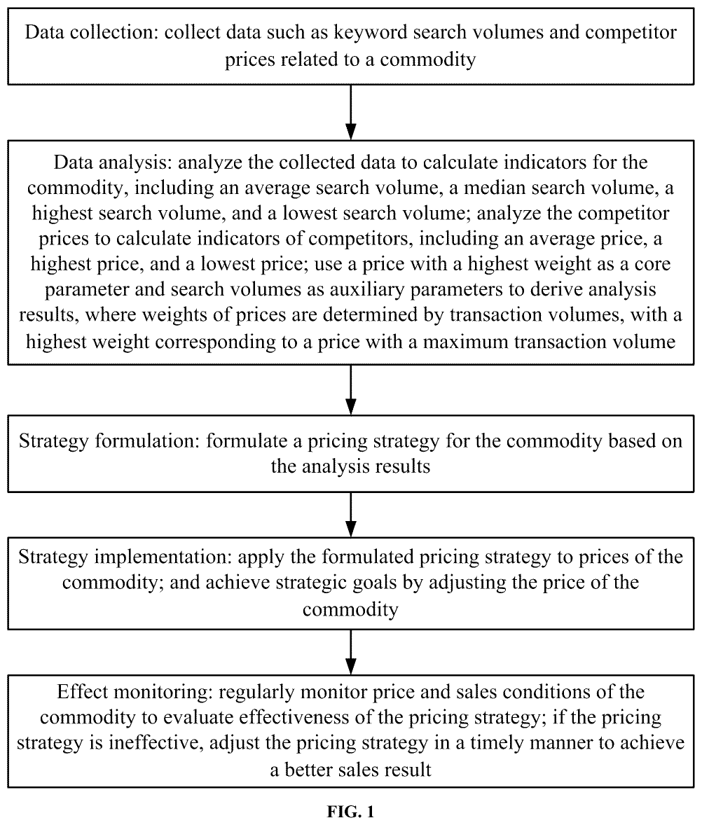

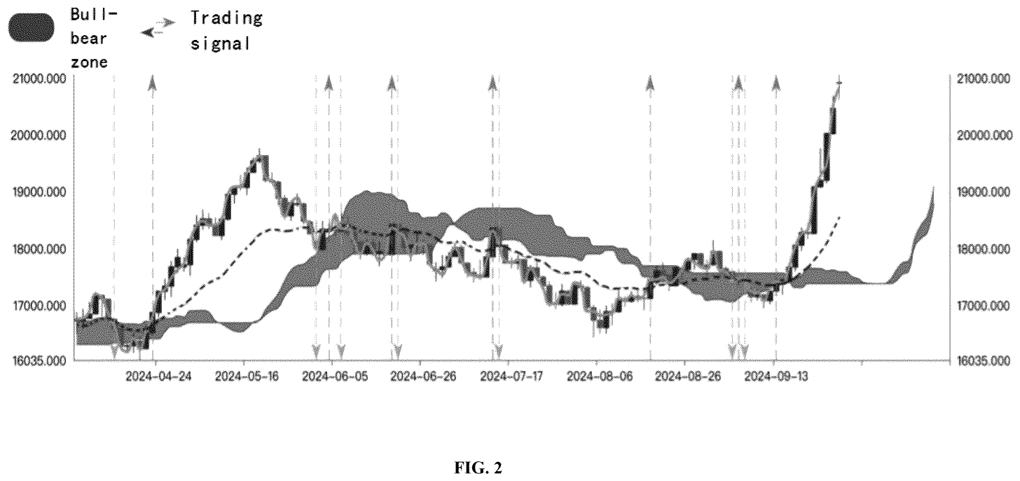

FIG. 2 is a schematic diagram of a volume price calculation trading signal according to the present disclosure, where
1. when the volume price is above the bull-bear zone, market sentiment is optimistic; conversely, when the volume price is below the bull-bear zone, sentiment is pessimistic;
2. the boundary lines of the upper and lower levels of the bull-bear zone can trigger changes in investor sentiment;
3. the solid line represents a trading price that occurs most frequently (aggregated price) for each period; the dashed line represents a price trend line; the intersection point where the solid price line crosses above the dashed line generates a price increase signal (↑); conversely, if the solid price line falls below the dashed line, it generates a price decrease signal (↓);
4. when the solid line and dashed line break above the upper level of the bull-bear zone, it indicates that the price increase rate will accelerate; conversely, if the price falls below the lower level of the bull-bear zone, the decrease rate will also accelerate;
5. the extension of the bull-bear zone can provide future support and resistance areas, allowing for a broader view of trends and key areas across different time periods, aiding in medium- to long-term market predictions.

### DETAILED DESCRIPTION OF THE EMBODIMENTS

The technical solutions of the present disclosure are described in more detail below with reference to the specific implementations.

### Embodiment 1

A computer system for implementing financial commodity price analysis is provided, including:
a data collection module configured to collect user search volume data and competitor price data related to a target product through web crawlers and API interfaces;
a data analysis module configured to process and analyze the collected data, and calculate average, median, standard deviation, and other statistical indicators of user search volumes, competitor prices, and aggregated prices, and can also perform data visualization for better understanding of the data;
a price suggestion generation module configured to generate a reasonable price suggestion based on data analysis results, where specifically, the price suggestion generation module can set reference thresholds based on the user search volumes, competitor prices, and volume price indicators, and generate a corresponding pricing suggestion based on the reference thresholds; additionally, the price suggestion generation module can also adjust the price suggestion considering market positioning, costs, and other factors; and
a result display module configured to display the generated pricing suggestion to a user in the form of charts or other formats, allowing the user to intuitively understand rationality of a pricing strategy.

The data collection module includes:
a web crawler collection unit configured to obtain the user search volume data from search engines;
an API interface collection unit configured to obtain the competitor price data from e-commerce platforms and other channels; and
a data storage unit configured to store the obtained data in a database for subsequent analysis and processing.

The data analysis module includes:
a data preprocessing unit configured to perform cleaning, deduplication, and missing value filling operations on the obtained data to improve accuracy and completeness of the data;
a statistical analysis unit configured to calculate the average, median, standard deviation, and other statistical indicators of the user search volumes and the competitor prices, and perform visualization;
a data mining unit configured to discover potential correlations and trends based on statistical analysis results, to provide reference for subsequent price suggestion generation; and
a report generation unit configured to generate a report of analysis results in the form of charts or other formats, allowing the user to intuitively understand the data analysis results.

The price suggestion generation module includes:
a threshold-based determining unit configured to determine a relationship between the user search volumes and the competitor prices based on the set thresholds, to provide a foundation for subsequent price suggestion generation;
a price suggestion generation unit configured to flexibly adjust the price suggestion based on market positioning, costs and other factors, to generate a reasonable pricing strategy; and
a suggestion feedback unit configured to provide the generated price suggestion to the user, allowing the user to timely adjust and optimize the pricing strategy.

The result display module includes:
a chart display unit configured to visually present the data analysis results in the form of line charts, bar charts, pie charts, or other formats;
a custom settings unit configured to support the user to customize chart styles, colors, fonts, and other parameters, to meet needs of different users; and
a data export unit configured to support exporting the data analysis results in Excel, CSV or other formats, facilitating further processing and analysis by the user.

The financial commodity price analysis system further includes:
a model establishment module configured to establish a prediction model or a decision tree model based on the analysis result, to provide more accurate reference for subsequent price suggestion generation.

The model establishment module includes:
a prediction model establishment unit configured to establish the prediction model, such as a linear regression model or a decision tree model, based on historical data;
a model evaluation unit configured to evaluate the established prediction model, for example, calculate and analyze mean squared error, precision, and recall metrics; and
a model optimization unit configured to optimize the established prediction models, for example, perform feature selection and parameter adjustment to improve prediction accuracy.

The financial commodity price analysis system further includes:
a real-time monitoring module configured to monitor market changes and competitor dynamics in real time, allowing for timely adjustments to the price suggestion to maintain competitiveness.

The real-time monitoring module includes:
a data collection unit configured to collect market data and competitor data in real time;
a data analysis unit configured to analyze the collected data, for example, perform trend analysis and competitive comparison; and
an alert setting unit configured to set alerts based on analysis results to promptly detect the market changes and competitor dynamics.

An analysis method of the financial commodity price analysis system includes the following steps:
S1: Data collection: collect data such as keyword search volumes, transaction volumes, competitor prices, and aggregated prices related to a commodity, where the data can be obtained using search engines or data interfaces from e-commerce platforms.
S2: Data analysis: analyze the collected data to calculate indicators for the commodity, including an average search volume, a median search volume, a highest search volume, and a lowest search volume; analyze the competitor prices to calculate indicators of competitors, including an average price, a highest price, and a lowest price; generate aggregated prices based on transaction prices per unit time, use a volume price indicator with a highest weight as a core parameter and search volumes as auxiliary parameters to derive analysis results, where weights of prices are determined by transaction volumes, with a highest weight corresponding to a price with a maximum transaction volume.
S3: Strategy formulation: formulate a pricing strategy for the financial commodity based on the analysis results; if a search volume of the financial commodity is low, consider lowering the price to attract more users; if the competitor prices are high, consider raising the price of the commodity to maintain competitiveness, where factors such as costs and profits also need to be considered.
S4: Strategy implementation: apply the formulated pricing strategy to prices of the financial commodity; and achieve strategic goals by adjusting the price of the financial commodity.
S5: Effect monitoring: regularly monitor price and sales conditions of the financial commodity to evaluate effectiveness of the pricing strategy; if the pricing strategy is ineffective, adjust the pricing strategy in a timely manner to achieve a better sales result.

The price suggestion generation module adopts the following scheme when pricing:
assuming that the number of competitors is n, and prices of the competitors are P1, P2, . . . , PN, price Pⱼ is obtained using the following formula:

$${P}_{j} = M \times ( 1 - x ) + P 1 \times ( 1 + r ) \times ( 1 + α 1 ) + P 2 \times ( 1 + r ) \times ( 1 + α 2 ) + … + PN \times ( 1 + r ) \times ( 1 + α N )$$

where M represents a market average price; x represents a competition degree of an enterprise in the market; r represents a profit margin of the enterprise; α represents an impact coefficient of the user search volume on financial commodity demand; (1−x) represents an actual selling price of the financial commodity considering market competition; and (1+r) represents an actual selling price of the financial commodity considering enterprise profit.

To more accurately reflect market demand and competition conditions, multiple parameters are introduced in this formula: x, r, α, and the prices of the competitors. The value of x can be assessed based on factors such as market share, brand awareness, and product quality, with a range from 0 to 1. The value of r can be adjusted based on the actual situation of the enterprise and market demand, and is a positive value. The value of α can be predicted and adjusted based on historical data and market trends. P1, P2, . . . , PN represent the prices and volume price indicators of the competitors.

The calculated and analyzed transaction price at the time node with the highest transaction volume is referred to as the volume price indicator. The specific calculation formula is as follows:

$$\sum {( f ( x ) - μ )}^{2} = 134.25$$

$$δ = \sqrt{\frac{\sum {( f ( x ) - μ )}^{2}}{n}} = 1.787$$

The process for obtaining specific quantitative indicators is as follows: First, a time and price distribution table is used, applying different time periods as the time frame, such as 1 minute, 3 minutes, 15 minutes, 1 hour, and 1 day, as shown in Table 1 and Table 2:

TABLE 1
Prices of a commodity for one hour on
2023 Aug. 1

| | | Transaction |
|---|---|---|
| Time | Price | volume |
| 2023 Aug. 1 09:00:00 | 19800 | 200 |
| 2023 Aug. 1 10:00:00 | 19820 | 600 |
| 2023 Aug. 1 11:00:00 | 19790 | 150 |
| 2023 Aug. 1 12:00:00 | 19810 | 110 |
| 2023 Aug. 1 13:00:00 | 19800 | 600 |
| 2023 Aug. 1 14:00:00 | 19760 | 300 |
| 2023 Aug. 1 15:00:00 | 19850 | 130 |
| 2023 Aug. 1 16:00:00 | 19830 | 100 |
| . . . | . . . | . . . |

TABLE 2
Prices of a commodity per hour on
2023 Aug. 1 (Time)

| | | Duration |
|---|---|---|
| Time | Price | (in minutes) |
| 2023 Aug. 1 09:00:00 | 19800 | 60 |
| 2023 Aug. 1 10:00:00 | 19820 | 60 |
| 2023 Aug. 1 11:00:00 | 19790 | 60 |
| 2023 Aug. 1 12:00:00 | 19810 | 60 |
| 2023 Aug. 1 13:00:00 | 19800 | 60 |
| 2023 Aug. 1 14:00:00 | 19760 | 60 |
| 2023 Aug. 1 15:00:00 | 19850 | 60 |
| 2023 Aug. 1 16:00:00 | 19830 | 60 |
| . . . | . . . | . . . |

Within the specified time period, the individual transaction prices are recorded, and the transaction volumes for each price (volume method) or price durations for each price (time method) are sorted to create a price-transaction volume table, as shown in Table 3 and Table 4:

TABLE 3
Volume-price transaction volume analysis
for a commodity on 2023 Aug. 1

| Price distribution | Transaction volume |
|---|---|
| 19800 | 800 |
| 19820 | 600 |
| 19790 | 150 |
| 19810 | 110 |
| 19760 | 300 |
| 19850 | 130 |
| 19830 | 100 |
| . . . | . . . |

TABLE 4
Volume-price transaction time analysis
for a product per hour on 2023 Aug. 1

| Price | Duration |
|---|---|
| distribution | (in minutes) |
| 19800 | 120 |
| 19820 | 60 |
| 19790 | 60 |
| 19810 | 60 |
| 19760 | 60 |
| 19850 | 60 |
| 19830 | 60 |
| . . . | . . . |

From the price transaction volume (volume method) or duration (time method) table, a price with a maximum transaction volume or duration is obtained. For example, in Table 3 and Table 4, the price of 19800 has a transaction volume of 800; the price of 19800 has a transaction duration of 120 minutes on the market, which is the volume price point, also referred to as the volume price indicator. Analyzing historical price data and real-time price data of the commodity through the volume price indicator can provide fairness and transparency for both parties in the transaction.

### Embodiment 2

A computer system for implementing financial commodity price analysis is provided, including:
a data collection module configured to collect user search volume data and competitor price data related to a target product through web crawlers and API interfaces;
a data analysis module configured to process and analyze the collected data, and calculate average, median, standard deviation, and other statistical indicators of user search volumes and competitor prices, where the data analysis module can also perform data visualization for better understanding of the data;
a price suggestion generation module configured to generate a reasonable price suggestion based on data analysis results, where specifically, the price suggestion generation module can set reference thresholds based on the user search volumes and competitor prices, and generate a corresponding pricing suggestion based on the reference thresholds; additionally, the price suggestion generation module can also adjust the price suggestion considering market positioning, costs, and other factors; and
a result display module configured to display the generated pricing suggestion to a user in the form of charts or other formats, allowing the user to intuitively understand rationality of a pricing strategy.

The data collection module includes:
a web crawler collection unit configured to obtain the user search volume data from search engines;
an API interface collection unit configured to obtain the competitor price data from e-commerce platforms and other channels; and
a data storage unit configured to store the obtained data in a database for subsequent analysis and processing.

The data analysis module includes:
a data preprocessing unit configured to perform cleaning, deduplication, and missing value filling operations on the obtained data to improve accuracy and completeness of the data;
a statistical analysis unit configured to calculate the average, median, standard deviation, and other statistical indicators of the user search volumes and the competitor prices, and perform visualization;
a data mining unit configured to discover potential correlations and trends based on statistical analysis results, to provide reference for subsequent price suggestion generation; and
a report generation unit configured to generate a report of analysis results in the form of charts or other formats, allowing the user to intuitively understand the data analysis results.

The price suggestion generation module includes:
a threshold-based determining unit configured to determine a relationship between the user search volumes and the competitor prices based on the set thresholds, to provide a foundation for subsequent price suggestion generation;
a price suggestion generation unit configured to flexibly adjust the price suggestion based on market positioning, costs and other factors, to generate a reasonable pricing strategy;
and
a suggestion feedback unit configured to provide the generated price suggestion to the user, allowing the user to timely adjust and optimize the pricing strategy.

The result display module includes:
a chart display unit configured to visually present the data analysis results in the form of line charts, bar charts, pie charts, or other formats;
a custom settings unit configured to support the user to customize chart styles, colors, fonts, and other parameters, to meet needs of different users; and
a data export unit configured to support exporting the data analysis results in Excel, CSV or other formats, facilitating further processing and analysis by the user.

The financial commodity price analysis system further includes:
a model establishment module configured to establish a prediction model or a decision tree model based on the analysis result, to provide more accurate reference for subsequent price suggestion generation.

The model establishment module includes:
a prediction model establishment unit configured to establish the prediction model, such as a linear regression model or a decision tree model, based on historical data;
a model evaluation unit configured to evaluate the established prediction model, for example, calculate and analyze mean squared error, precision, and recall metrics; and
a model optimization unit configured to optimize the established prediction models, for example, perform feature selection and parameter adjustment to improve prediction accuracy.

The financial commodity price analysis system further includes:
a real-time monitoring module configured to monitor market changes and competitor dynamics in real time, allowing for timely adjustments to the price suggestion to maintain competitiveness.

The real-time monitoring module includes:
a data collection function configured to collect market data and competitor data in real time;
a data analysis function configured to analyze the collected data, for example, perform trend analysis and competitive comparison; and
an alert setting function configured to set alerts based on analysis results to promptly detect the market changes and competitor dynamics.

An analysis method of the financial commodity price analysis system includes the following steps:
S1: Data collection: collect data such as keyword search volumes and competitor prices related to a financial commodity, where the data can be obtained using search engines or data interfaces from e-commerce platforms.
S2: Data analysis: analyze the collected data to calculate indicators for the financial commodity, including an average search volume, a median search volume, a highest search volume, a lowest search volume, and a volume price indicator; analyze the competitor prices to calculate indicators of competitors, including an average price, a highest price, and a lowest price; use a price with a highest weight as a core parameter and search volumes as auxiliary parameters to derive analysis results, where weights of prices are determined by transaction volumes, with a highest weight corresponding to a price with a maximum transaction volume.
S3: Strategy formulation: formulate a pricing strategy for the financial commodity based on the analysis results; if a search volume of the financial commodity is low, consider lowering the price to attract more users; if the competitor prices are high, consider raising the price of the commodity to maintain competitiveness, where factors such as costs and profits also need to be considered.
S4: Strategy implementation: apply the formulated pricing strategy to prices of the financial commodity; and achieve strategic goals by adjusting the price of the financial commodity.
S5: Effect monitoring: regularly monitor price and sales conditions of the financial commodity to evaluate effectiveness of the pricing strategy; if the pricing strategy is ineffective, adjust the pricing strategy in a timely manner to achieve a better sales result.

The price suggestion generation module adopts the following scheme when pricing:
assuming that the number of competitors is n, and prices of the competitors are P1, P2, . . . , PN, price Pⱼ is obtained using the following formula:

$${P}_{j} = M \times ( 1 - x ) + P 1 \times ( 1 + r ) \times ( 1 + α 1 ) + P 2 \times ( 1 + r ) \times ( 1 + α 2 ) + … + PN \times ( 1 + r ) \times ( 1 + α N )$$

where M represents a market average price; x represents a competition degree of an enterprise in the market; r represents a profit margin of the enterprise; α represents an impact coefficient of the user search volume on commodity demand; (1−x) represents an actual selling price of the commodity considering market competition; and (1+r) represents an actual selling price of the commodity considering enterprise profit.

To more accurately reflect market demand and competition conditions, multiple parameters are introduced in this formula: x, r, α, and the prices of the competitors. The value of x can be assessed based on factors such as market share, brand awareness, and product quality, with a range from 0 to 1. The value of r can be adjusted based on the actual situation of the enterprise and market demand, and is a positive value. The value of α can be predicted and adjusted based on historical data and market trends. P1, P2, . . . , PN represent the prices of the competitors.

The financial commodity price analysis system further includes:
a multi-user management module configured to support multiple users to view and edit analysis results simultaneously, to improve collaboration efficiency.

The multi-user management module includes:
a user permission management unit configured to set different permissions for different users, including viewing, editing, and deleting;
a user identity verification unit configured to verify user identities to ensure that only authorized users can access the system; and
a user log recording unit configured to record user operation logs for easy tracing and management.

The present disclosure proposes a computer-based method for statistical analysis of financial commodity transaction data to obtain maximum weighted prices and a computer-based method for analyzing financial product price trend charts. By collecting microsecond-level transaction data of the financial commodity in real time and calculating the maximum weighted price (aggregated price) for a certain period, the method computes the aggregated indicator, bull and bear zones, aggregated price trend indicator (MTTI), and trading signals generated between the aggregated price and the bull-bear zone indicator as well as the MTTI indicator. These are combined to form price trend graphics. The maximum weighted price is referred to as the “aggregated price” in the present disclosure, and the graphical representation based on the aggregated price is called the “Ichimoku Kinko Hyo” chart in the present disclosure. The present disclosure has the following advantages:
1. Real-time calculation of financial and commodity transactions 24 hours a day enhances transparency and timeliness, realizing the principle of market economy openness.
2. The pricing mechanism for long-term bulk commodities (e.g., oil) uses the closing price as a base to calculate the average price for a certain period. The closing price is easily manipulated, leading to unfairness for one party in the transaction. The aggregated price increases the difficulty of manipulation and improves trading fairness.
3. Based on the aggregated price, it serves as a pricing standard for various financial products, reducing market manipulation and disputes, and enhancing market fairness principles.
4. Abandoning the traditional single price of OHLC centered around the closing price improves the accuracy of price references.
5. Actual market demand is recorded more accurately.
6. The most densely traded prices on the market, trends, and price support and breakout points that stimulate changes in investor sentiment are displayed.
7. The present disclosure considers fluctuations in trading volume, providing a more reliable price reference.
8. The method is simple and easy to implement, suitable for financial trading markets of various financial product types.
9. The present disclosure digs into the hidden patterns and relationships in trading big data, analyzing various basic data such as price, trading volume, and aggregation points within the cycle. Using the artificial intelligence (AI) technology, data is transformed into charts, including predicting market price trends, indicating buy or sell price levels, and fitting unique charts that reflect market sentiment.

The above are merely preferred specific embodiments of the present disclosure, but the protection scope of the present disclosure is not limited thereto. Any equivalent replacement or modification made by a person skilled in the art according to the technical solutions of the present disclosure and inventive concepts thereof within the technical scope of the present disclosure shall fall within the protection scope of the present disclosure.

What is claimed is:

1. A computer system for implementing financial commodity price analysis, comprising:
a data collection module configured to collect user search volume data and competitor price data related to a target product through web crawlers and application programming interfaces (APIs); and collect transaction price data and transaction volume data per transaction unit time to form volume price indicators;
a data analysis module configured to process and analyze the collected data, calculate average, median, and standard deviation statistical indicators of user search volumes and competitor prices, and generate a price with a highest weight based on comparison of transaction volumes within a unit time, also known as the volume price indicator;
a price suggestion generation module configured to generate a reasonable price suggestion based on data analysis results; and set reference thresholds based on the user search volumes and the competitor prices, and generate a corresponding pricing suggestion based on the reference thresholds; and
a result display module configured to display the generated pricing suggestion to a user in the form of charts or other formats, allowing the user to intuitively understand rationality of a pricing strategy.

2. The computer system for implementing financial commodity price analysis according to claim 1, wherein the data collection module comprises:
a web crawler collection unit configured to obtain the user search volume data from search engines;
an API interface collection unit configured to obtain the competitor price data from e-commerce platforms and other channels; and
a data storage unit configured to store the obtained data in a database for subsequent analysis and processing.

3. The computer system for implementing financial commodity price analysis according to claim 1, wherein the data analysis module comprises:
a data preprocessing unit configured to perform cleaning, deduplication, and missing value filling operations on the obtained data to improve accuracy and completeness of the data;
a statistical analysis unit configured to calculate the average, median, standard deviation, and other statistical indicators of the user search volumes and the competitor prices, determine an aggregated price based on a maximum transaction volume per unit time, and perform visualization;
a data mining unit configured to discover potential correlations and trends based on statistical analysis results, to provide reference for subsequent price suggestion generation; and
a report generation unit configured to generate a report of analysis results in the form of charts or other formats, allowing the user to intuitively understand the data analysis results.

4. The computer system for implementing financial commodity price analysis according to claim 1, wherein the price suggestion generation module comprises:
a threshold-based determining unit configured to determine a relationship between the user search volumes and the competitor prices based on the set thresholds, to provide a foundation for subsequent price suggestion generation;
a price suggestion generation unit configured to flexibly adjust the price suggestion based on market positioning and cost factors, to generate a reasonable pricing strategy; and
a suggestion feedback unit configured to provide the generated price suggestion to the user, allowing the user to timely adjust and optimize the pricing strategy.

5. The computer system for implementing financial commodity price analysis according to claim 1, wherein the result display module comprises:
a chart display unit configured to visually present the data analysis results in one or more of the following formats: line charts, bar charts, or pie charts;
a custom settings unit configured to support the user to customize chart styles, colors, fonts, and other parameters, to meet needs of different users; and
a data export unit configured to support exporting the data analysis results in Excel or CSV formats, facilitating further processing and analysis by the user.

6. The computer system for implementing financial commodity price analysis according to claim 1, further comprising:
a model establishment module configured to establish a prediction model or a decision tree model based on the analysis result, to provide more accurate reference for subsequent price suggestion generation;
wherein the model establishment module comprises:
a prediction model establishment unit configured to establish the prediction model based on historical data;
a model evaluation unit configured to evaluate the established prediction model, comprising calculation and analysis of mean squared error, precision, and recall metrics; and
a model optimization unit configured to optimize the established prediction model, comprising feature selection and parameter adjustment to improve prediction accuracy.

7. The computer system for implementing financial commodity price analysis according to claim 1, further comprising:
a real-time monitoring module configured to monitor market changes and competitor dynamics in real time, allowing for timely adjustments to the price suggestion to maintain competitiveness;
wherein the real-time monitoring module comprises:
a data collection unit configured to collect market data and competitor data in real time;
a data analysis unit configured to analyze the collected data, comprising trend analysis and competitive comparison; and
an alert setting unit configured to set alerts based on analysis results to promptly detect the market changes and competitor dynamics.

8. The computer system for implementing financial commodity price analysis according to claim 1, further comprising:
a graphical analysis module configured to calculate a bull-bear zone indicator for a target period, an aggregated price trend indicator (MTTI), and trading signals generated between the aggregated price and the bull-bear zone indicator as well as the MTTI indicator.

9. The computer system for implementing financial commodity price analysis according to claim 1, further comprising:
a multi-user management module configured to support multiple users to view and edit analysis results simultaneously, to improve collaboration efficiency;
wherein the multi-user management module comprises:
a user permission management unit configured to set different permissions for different users, comprising viewing, editing, and deleting;
a user identity verification unit configured to verify user identities to ensure that only authorized users are allowed to access the system; and
a user log recording unit configured to record user operation logs for easy tracing and management.
